(19) United States
(12) Patent Application Publication
(10) Pub. No.: US 2014/0274751 A1
(43) Pub. Date: Sep. 18, 2014

(54) CHEMICAL IDENTIFICATION USING A CHROMATOGRAPHY RETENTION INDEX

(71) Applicants: Charles Sadowski, Danbury, CT (US); Greger Andersson, Oxford, CT (US); Kevin Judge, Danbury, CT (US)

(72) Inventors: Charles Sadowski, Danbury, CT (US); Greger Andersson, Oxford, CT (US); Kevin Judge, Danbury, CT (US)

(73) Assignee: SMITHS DETECTION INC., Danbury, CT (US)

(21) Appl. No.: 14/237,106

(22) PCT Filed: Aug. 3, 2012
(86) PCT No.: PCT/US12/49571

§ 371 Date: Jun. 4, 2014

Related U.S. Application Data
(60) Provisional application No. 61/515,722, filed on Aug. 5, 2011.
(60) Provisional application No. 61/647,299, filed on May 15, 2012.

(51) Int. Cl. G06F 19/00

(52) U.S. Cl. CPC G06F 19/703
USPC 506/8; 506/13; 703/12

(57) ABSTRACT

Provided herein is technology relating to identifying unknown compounds and particularly, but not exclusively, to methods and systems for identifying unknown compounds by gas chromatography-mass spectrometry by use of retention index as a second dimension for identification.

This application claims priority to U.S. Pat. Appl. Ser. No. 61/515,722 (filed Aug. 5, 2011) and U.S. Pat. Appl. Ser. No. 61/647,299 (filed May 15, 2012), both of which are incorporated herein by reference.

### FIELD OF INVENTION

Provided herein is technology relating to identifying unknown compounds and particularly, but not exclusively, to methods and systems for identifying unknown compounds by gas chromatography and mass spectrometry.

### BACKGROUND

Currently, identifying unknowns using mass standard spectral libraries is based solely on spectral match qualities. When libraries are pre-screened to select a subset of the library comprising a set of match candidates, conventional pre-screening approaches are based on spectral characteristics. However, in some cases these solutions fail to include the correct compound in the list of pre-screened candidates. Moreover, numerous compounds that cannot be matches based on the chromatographic conditions are included in the set of pre-screened candidates, which further complicates correct identification. Thus, despite the availability of sensitive GC-MS systems and extensive databases for identifying unknown compounds, the art requires a more reliable and/or efficient identification of unknown compounds.

### SUMMARY

Accordingly, provided herein is technology relating to identifying unknown compounds and particularly, but not exclusively, to methods and systems for identifying unknown compounds by gas chromatography and mass spectrometry using a retention index related to retention time as a primary pre-screen to select the appropriate list of candidate spectra for matching from a conventional standard reference library. The estimated retention index is used as one criterion in determination of the final match score in addition to mass spectral qualities (or other properties if mass spectroscopy is not used). Predicting the retention index of library compounds leads to higher quality initial search lists and more reliable identification. This eliminates the need for running additional standards or post-analysis experiments to allow or confirm identification by retention time. Further, use of the predicted retention index improves the quality of unknown identification.

In some embodiments, provided herein are methods and systems for generating a database or library of compounds with associated retention indices or other retention time indicators. In some embodiments, entries in the database or library include compounds having retention indices related to retention time generated by modeling rather than by experiment. In some embodiments, such indicators are determined by virtual analysis of a compound and assignment of a predicted retention indicator based on the virtual analysis. In some embodiments, the virtual analysis comprises: a) selecting individual atoms or chemical groups and their bonding from the compound (e.g., —CH₃, —CH₂—, etc.), b) assigning a retention value (e.g., a coefficient) to the atom or group based on a training data set comprising identical or similar atoms or groups from compounds with known (e.g., experimentally determined) retention data, and c) summing the retention values from the individual atoms/groups to generate a predicted retention time indicator for the molecule. In some embodiments, the nature of the initial molecule is used to select training data set most likely to provide accurate results (e.g., the training set data is based on molecules of a similar structure or a similar class of compounds as the query compound). As such, provided herein are more complete compound databases/libraries that contain compounds having either or both of experimentally or virtually determined retention time data associated with them.

In some embodiments, the entire collection of compounds to be screened is present in two or more separate databases or libraries. In some embodiments, the individual members of the two or more separate databases or libraries contain compounds having related characteristics. In some embodiments, the characteristic is the accuracy of the retention index data associated with the compound (e.g., a first database may have compounds known to have accurate data and a second database may have compounds known or predicted to have less accurate data). In some embodiments, the characteristic is the structural class of the compound (e.g., organic, inorganic, alkane, alkyl, aromatic, aryls, etc.). In some embodiments, the characteristic is the functional use of the compound (e.g., solvents, warfare agents, toxins, etc.).

In some embodiments, provided herein are methods and systems that permit the accurate and efficient identification of an unknown compound. In some embodiments, a retention index curve is generated by the use of two or more known compounds. An estimated retention index (e.g., an estimated Kovats retention index or EKRI) is calculated by measuring retention time (RT) of the unknown compound and associating the measured RT with the slope of the KRI curve.

In some embodiments, the EKRI is then used to select a subset of molecules in the databases or libraries. For example, in some embodiments, any compound in a given library within a particular range (e.g., 20 KRI units) of the EKRI is selected as a candidate for further analysis. In some embodiments, the window used varies as desired and may vary from library to library based on factors including, but not limited to, the precision of the data in the library (e.g., a smaller window is used when a highly precise library is queried), the nature of the compounds in the library, and the like. Once selected, the subset of candidates is then compared to other collected information to identify the compound or compounds in the library that best match the measured properties of the unknown. For example, in some embodiments, various mass spectral properties determined from the unknown are compared to the corresponding properties of the candidate subset of compounds to select the best match and identify the unknown compound.

In some embodiments, all components needed to carry out the methods are housed in a single device. For example, a GC-MS instrument may comprise the databases of known compounds and processor and/or software configured to analyze the data as described in any of the methods herein. Alternatively, one or more functions may be provided in a separate device which may be located near or distantly from the GC-MS instrument. For example, databases and/or data analysis components may be present on a computer located a distance from the GC-MS instrument. Data is transferred between the GC-MS and the computer over a communication network (e.g., a secured wireless communication network, etc.).

Thus, in some embodiments, the technology provides a method for identifying an unknown compound using gas chromatography-mass spectrometry (GC-MS), wherein the method comprises estimating a predicted retention index for a standard compound based on an atomic structure of the standard compound; and assigning the predicted retention index to the standard compound. In some embodiments, the method of estimating the predicted retention index for a standard compound based on an atomic structure of the standard compound comprises determining an atom type and a bond type for each atom of the standard compound; selecting a reference compound from a database, wherein the reference compound has a known retention index and consists of the same atom types and the same bond types as the standard compound; assigning a coefficient to each atom of the reference compound, wherein the coefficient characterizes the contribution of an atom to the known retention index of the reference compound; and using the coefficient to estimate a retention index for the standard compound. In some embodiments, the method comprises selecting a plurality of reference compounds from the database to provide a training set, wherein each compound of the training set has a known retention index and consists of the same atom types and the same bond types as the standard compound. In some embodiments, assigning a coefficient comprises constructing a matrix. In particular, some embodiments provide that a column of the matrix corresponds to the atom type and a row of the matrix corresponds to a compound from the database, wherein the compound has a known retention index and consists of the same atom types and the same bond types as the standard compound.

In some embodiments, the method comprises determining a precision of the estimated retention index. The precision is used in some embodiments, for example, to sort a database using the precision of the estimated retention index, to partition a database using the precision of the estimated retention index, or to provide a search window.

Furthermore, embodiments of the technology provided herein comprise estimating a retention index for the unknown compound assayed by GC-MS. In some embodiments, estimating a retention index for the unknown compound assayed by GC-MS comprises measuring a retention time of the unknown compound and converting the retention time of the unknown compound to the retention index for the unknown compound using a known relationship between retention time and retention index. In some embodiments, the methods further comprise using the retention index for the unknown compound to preselect standard compounds from a database and matching the unknown compound to a standard compound.

Accordingly, one aspect of the technology relates to a method for identifying an unknown compound using GC-MS, wherein the method comprises estimating retention indices for the compounds of a standard library based on the atomic structure of each compound; estimating a retention index for an unknown compound using the GC-MS retention time data for the unknown compound and a known relationship between retention time and retention index; and using the retention index estimated for the unknown compound to preselect a subset of library compounds from the standard library for subsequent match identification.

Moreover, the technology described finds use in a system for identifying an unknown compound using GC-MS, the system comprising a GC-MS apparatus; a database of standard compounds; and a processor configured to perform an embodiment of one of the methods as described above. In some embodiments, the GC-MS apparatus is remote from the database of standard compounds. In some embodiments the processor is configured to provide a library of standard compounds indexed by retention index and in some embodiments the processor is configured to select a sublibrary from the database of standard compounds. Some embodiments provide that the database of standard compounds is partitioned into two or more sublibraries.

Additional embodiments will be apparent to persons skilled in the relevant art based on the teachings contained herein. For example, it should be understood that the methods described herein are not limited to the use of GC-MS analysis. A wide variety of chromatography or other analytical techniques can employ one or more aspects of the technology described herein.

### BRIEF DESCRIPTION OF THE DRAWINGS

These and other features, aspects, and advantages of the present technology will become better understood with regard to the following drawings:

FIG. 1 is a plot of KRI from the NIST library versus the EKRI for 26 compounds as determined using a first GC-MS instrument

FIG. 2 is a plot of KRI from the NIST library versus the EKRI for 26 compounds as determined using a second GC-MS instrument

FIG. 3 is a plot comparing the two EKRIs for 26 compounds as determined using the two instruments referenced in FIGS. 1 and 2

### DETAILED DESCRIPTION

Provided herein is technology relating to identifying unknown compounds and particularly, but not exclusively, to methods and systems for identifying unknown compounds by gas chromatography and mass spectrometry using a calculated KRI based on a measured retention time as a primary pre-screen to select the appropriate list of candidate spectra for matching from a conventional MS standard reference library. The estimated KRI is used as one criterion in determination of the final match score in addition to mass spectral qualities (or other properties if mass spectroscopy is not used). Predicting the KRI or retention time of library compounds leads to higher quality initial search lists and more reliable identification. This eliminates the need for running additional standards or post-analysis experiments to allow or confirm identification by RT. Further, use of the predicted KRI improves identification quality.

### DEFINITIONS

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, “Kovats retention index” (KRI) is refers to a particular predictor of the retention time of a chemical in gas chromatography. KRI finds use in identifying unknown compounds in gas chromatography. A compound's KRI is related to its retention time (the amount of time it spends in the column) and is specific to the conditions of sample analysis, e.g., type of column, liquid phase, flow rate, temperature program, etc.

As used herein, a “chemical compound” or “compound” is a pure chemical substance consisting of one or more different chemical elements that can be separated into simpler substances by chemical reactions. Chemical compounds have a unique and defined chemical structure, and they consist of a fixed ratio of atoms that are held together in a defined spatial arrangement by chemical bonds. Chemical compounds can be molecular compounds (a “molecule”) held together by covalent bonds, salts held together by ionic bonds, intermetallic compounds held together by metallic bonds, or complexes held together by coordinate covalent bonds. As used herein, pure chemical elements are considered chemical compounds even if they consist of molecules that contain only multiple atoms of a single element (such as H₂, S₈, etc.).

### Embodiments of the Technology

Although the disclosure herein refers to certain illustrated embodiments, it is to be understood that these embodiments are presented by way of example and not by way of limitation.

Gas chromatography—mass spectrometry (GC-MS) is a method that combines the features of gas-liquid chromatography and mass spectrometry to identify different substances within a test sample. In this technique, a gas chromatograph (GC) is used to separate different compounds. This stream of separated compounds is fed online into a mass spectrometer ion source, e.g., a metallic filament to which voltage is applied. This filament emits electrons which ionize the compounds. The ions can then further fragment, yielding predictable patterns. Intact ions and fragments pass into the mass spectrometer's analyzer and are eventually detected. Applications of GC-MS include drug detection, fire investigation, environmental analysis, explosives investigation, and identification of unknown samples. GC-MS can also be used in airport security to detect substances in luggage or on human beings or in a military setting to detect, e.g., chemical and/or biological warfare agents, explosives, propellants, and other chemical signatures of interest. Additionally, it can identify trace elements in materials that were previously thought to have disintegrated beyond identification.

Gas chromatography (GC) is used for separating and analyzing compounds that can be vaporized without decomposition. Typical uses of GC include testing the purity of a particular substance, or separating the different components of a mixture (the relative amounts of such components can also be determined). In some situations, GC may help in identifying a compound. In preparative chromatography, GC can be used to prepare pure compounds from a mixture.

In gas chromatography, the mobile phase is a carrier gas, usually an inert gas such as helium or an un-reactive gas such as nitrogen. The stationary phase is a microscopic layer of liquid or polymer on an inert solid support, inside a piece of glass or metal tubing called a column. The instrument used to perform gas chromatography is called a gas chromatograph. The gaseous compounds being analyzed interact with the walls of the column, which is coated with different stationary phases. This causes each compound to elute at a different time, known as the retention time of the compound. The comparison of retention times is what gives GC its analytical usefulness. The separation of the compounds on the column provides for preparatory and downstream analytical applications.

Mass spectrometry (MS) is an analytical technique that measures the mass-to-charge ratio of charged particles. It is used for determining masses of particles, for determining the elemental composition of a sample or molecule, and for elucidating the chemical structures of molecules, such as peptides and other chemical compounds. The MS principle consists of ionizing chemical compounds to generate charged molecules or molecule fragments and measuring their mass-to-charge ratios. The ionized fragments are separated according to their mass-to-charge ratio in an analyzer by electromagnetic fields and the ions are detected, usually by a quantitative method, to produce a mass spectrum.

Since the precise structure of a molecule is deciphered through the set of fragment masses, the interpretation of mass spectra requires combined use of various techniques. Usually the first strategy for identifying an unknown compound is comparing its experimental mass spectrum against a library of mass spectra. If the search yields no results, then manual interpretation or software-assisted interpretation of mass spectra is performed. Computer simulation of ionization and fragmentation processes occurring in mass spectrometry is the primary tool for assigning structure to a molecule. An a priori structure is fragmented in silico and the resulting pattern is compared with an observed spectrum. Such simulation is often supported by a fragmentation library that contains published patterns of known decomposition reactions. Software taking advantage of this idea has been developed for both small molecules and proteins.

Provided herein is technology related to identifying an unknown compound based on comparison of GC-MS data to a database of standard compounds. In particular, the technology comprises:
1) Calculating a predicted KRI for the compounds of a standard library based on the atomic structure of each compound;
2) Calculating a KRI for an unknown compound using i) the GC-MS RT data for the unknown and ii) a known relationship between RT and KRI to convert the measured RT to a predicted KRI; and
3) Using the KRI calculated for the unknown to preselect a subset of library compounds for subsequent match identification.
   Exemplary aspects of this technology are further described below.

### 1. Determining KRI for Compounds in the Standards Databases

Kovats retention index (KRI) is a predictor of the retention time of a chemical in gas chromatography. KRI has been used as an aid in identification of unknown compounds in gas chromatography for decades. A compound's KRI is related to its retention time (the amount of time it spends in the column) and is specific to the conditions of sample analysis, e.g., type of column, liquid phase, flow rate, temperature program, etc. The KRI has not been used for broad-based identification of unknowns.

As demonstrated herein, KRI is a useful for identifying unknown compounds by GC-MS. Given a retention window, a database can be filtered based on KRI. One advantage of using such a filter is the elimination of compounds with similar mass spectra that elute at different times, thus reducing the number of potential candidates that may be matches for the unknown. However, KRI has not been measured for all compounds compiled in the databases commonly used for the identification of unknowns. Thus, provided herein are methods for estimating KRI from a compound's structure.

In general, an algorithm is used to predict the KRI for compounds in a general purpose mass spectral library based on the chemical formula and structure. The predicted KRI is then used to estimate a retention time for the library compound for a specific set of conditions, type of column, liquid phase, and temperature program. Total unknown identification with GC-MS is historically based on mass spectrum only. The ability to estimate the retention time of a compound based on the structure and formula enables retention time to be included as a key element in the unknown search criteria, greatly improving the quality of the identification. The algorithm is incorporated into a mass spectral search program using the estimated retention time as a pre-screen to select the appropriate list of candidate spectra for matching from the reference library. The estimated retention time is used as one criterion to determine of the final match score in addition to mass spectral qualities.

Specifically, KRI estimation utilizes molecular structure, which is information provided by the standards databases, e.g., as provided by NIST. The structure of a molecule is broken down into its component atoms and bond types. Each unique atom is represented as a separate variable, coded using atomic numbers, bond types, and whether or not it is in a ring. Using a training set of similar compounds with known KRIs, the contribution of each type of atom to the KRI is calculated with a least squares fit. These values are used for coefficients that are applied to new molecules with the same kinds of atoms. In addition to the predicted KRI, an estimate of precision is determined through cross-validation on the training set. Both the KRI and precision are valuable in filtering library compounds.

To demonstrate this method, the following chemical will be used as an example.

| Name: | 4-penten-1-ol |
|---|---|
| CAS: | 821090 |
| Formula: | C₅H₁₀O |
| Molecular Structure: | C═C—C—C—C—O—H |
| Atom number | 1 2 3 4 5 6 |

Ignoring the hydrogen atoms, there are 6 atoms—5 carbon atoms and 1 oxygen atom. Each atom is recorded using the previously described coding scheme.

| | | | |
|---|---|---|---|
| atom (1): | 60 | 62 | |
| atom (2): | 60 | 62 | 61 |
| atom (3): | 60 | 61 | 61 |
| atom (4): | 60 | 61 | 61 |
| atom (5): | 60 | 81 | 61 |
| atom (6): | 80 | 61 | |

The first value of atom (1) identifies it as a carbon atom (atomic number of 6) and that it is not in a ring (the 6 is followed by a 0). The next value designates that it is bonded to another carbon atom (again a 6 is used) and that it is a double bond (the 6 is followed by a 2). Note that using this scheme, there is no difference between atoms (3) and (4). Therefore, there are only 5 unique atoms, each with a coefficient that needs to be calculated.

Using the five unique variables, the next step is to find the library entries with known KRIs that consist of these atoms and only these atoms. From the 15,005 member library of compounds having a known KRI, there are 7 entries that satisfy these criteria.
1. 3-buten-1-ol
2. 11,13-tetradecadien-1-ol
3. 9,11-dodecadien-1-ol
4. 5-hexen-1-ol
5. 10-undecen-1-ol
6. 9-decen-1-ol
7. 11-dodecenol

Using these compounds, a matrix is constructed. In particular, this list of compounds will yield a 7×5 matrix wherein each row represents one of the 7 library entries and each column represents one of the 5 types of unique atoms. The values of the matrix are the numbers of each type of atom each compound contains. Thus, the row for the test sample, 4-penten-1-ol, reads [1 1 2 1 1]. Using the 7 known samples, coefficients for each variable are calculated using least squares optimization. The predicted KRI is then the linear combination:

KRI=1*b1+1*b2+2*b3+1*b4+1*b5

wherein b1, b2, b3, b4, and b5 are the coefficients for each type of unique atom calculated above.

The precision is calculated using a leave-one-out cross-validation approach. For instance, first 3-buten-1-ol is removed from the training set and coefficients are estimated using the remaining 6 entries. A prediction for 3-buten-1-ol is calculated using the coefficients and compared to the known value. This process is repeated by removing and then calculating a predicted value for each of the 7 entries. The precision is calculated as the root mean square of the cross-validation errors.

In some embodiments, a KRI is calculated for all the compounds collected in a library of known standard compounds (e.g., a standard database such as provided by NIST). The calculated precision of the predicted KRIs, which is related to the anticipated error in identifying a match for the unknown, is used to sort and partition the library into sublibraries. The precision for the sublibrary is also used to determine the breadth of the window (e.g., the range of KRI values to search, which, in some embodiments is centered on the predicted KRI (e.g., as predicted from the retention time) for an unknown compound) used for matching an unknown compound to the sublibrary by comparing the predicted KRI for the unknown compound to a range (within the window) of calculated KRIs (e.g., as predicted or estimated from their known chemical structures) for the database of standards. For example, a larger window is used when the anticipated error in identifying a match is greater and a smaller window is used when the anticipated error in identifying a match is less. Moreover, in some embodiments the library or sublibrary is presorted by KRI to make an indexed lookup table based on the sorted KRI. The lookup table (e.g., index) is used to identify a sublibrary or to select a range of entries within a sublibrary or library to use for identifying matches to the GC-MS data.

In some embodiments the algorithms are manifested in software. In some embodiments the software is associated with an apparatus. In one aspect, the apparatus is an apparatus comprising a GC-MS. Some embodiments of the technology provided herein further comprise functionalities for collecting, storing, and/or analyzing data. For example, in some embodiments the apparatus comprises a processor, a memory, and/or a database for, e.g., storing and executing instructions, analyzing data, performing calculations using the data, transforming the data, and storing the data. In some embodiments the apparatus stores a database of reference standards and in some embodiments the database of reference standards is stored remotely (e.g., on a remote computer, on a remote server). In some embodiments, the apparatus is configured to calculate a function of data. In some embodiments the apparatus comprises software configured for medical or clinical results reporting and in some embodiments the apparatus comprises software to support non-clinical results reporting.

Many molecular tests involve determining the presence or absence, or measuring the amount or concentrations of, multiple analytes, and an equation comprising variables representing the properties of multiple analytes produces a value that finds use in making a diagnosis or assessing the presence or qualities of an analyte. As such, in some embodiments the reading apparatus calculates this value and, in some embodiments, presents the value to the user of the apparatus, uses the value to produce an indicator related to the result (e.g., an LED, an icon on an LCD, a sound, or the like), stores the value, transmits the value, or uses the value for additional calculations.

Moreover, in some embodiments a processor is configured to control the apparatus. In some embodiments, the processor is used to initiate and/or terminate the measurement and data collection. In some embodiments, the apparatus comprises a user interface (e.g., a keyboard, buttons, dials, switches, and the like) for receiving user input that is used by the processor to direct a measurement. In some embodiments, the apparatus further comprises a data output for transmitting (e.g., by a wired or wireless connection) data to an external destination, e.g., a computer, a display, a network, and/or an external storage medium. For example, in some embodiments, the system communicates with PC devices via ethernet and an internal RF modem (e.g., an XBee ZB Pro, which provides interoperability with ZigBee devices from other vendors) is incorporated to facilitate easy download of data. Some aspects of the technology provide that the data communication is encrypted to secure sensitive data during transmission. Some embodiments provide that the apparatus is a small, handheld, portable device incorporating these features and components.

In some embodiments, the standards database and calculated KRI values are stored at a location remote from the GC-MS testing or apparatus. For example, in some embodiments, the apparatus is used to test a substance in the field and the standards data are kept at a base of operations (e.g., a headquarters or command post, etc.). In some embodiments, the standards database and calculated KRI values are stored associated within a functionality associated with the GC-MS testing or apparatus (e.g., a flash memory, a hard disk, etc.). Embodiments provide that the apparatus in the field and computer facilities at a base are in communication (e.g., wired or wireless) with one another.

In some embodiments, the KRI predictions are adaptively updated based on the addition of new data and new training sets associated with new compounds, fragments, and atoms. In some embodiments, the KRI values find use in explaining MS peaks based on known ion chemistries of MS (e.g., rationalizing unanticipated or unexplainable peaks, explaining impurities, weighting the MS molecular fragment, etc.). In some embodiments, the operational parameters of the MS are varied based on KRI information obtained for an unknown and its possible match candidates.

### 2. Calculating a Predicted KRI for an Unknown

Accordingly, one aspect of the technology provided herein relates to deconvolution of full known and unknown mass spectra and pre-screening of spectral match candidates from a standard reference library based on retention index (e.g., KRI). In one aspect, an algorithm is implemented in a software program for GC-MS peak identification and deconvolution of known and unknown compound mass spectra. This algorithm produces accurate retention times and groups masses according to retention times. It also uses a spectral analysis algorithm to remove background noise and electronic noise from the GC-MS data. This greatly reduces the problem of false positives in the compound identification routines. In addition, the use of high resolution GC permits the accurate calculation of retention indexes for unknown compounds which have been deconvolved. Comparing highly accurate RIs of unknowns to the RIs of compounds from the reference library (e.g., the NIST database), the possible compound matches can be predicted with a high degree of accuracy. RIs calculated from a compound's retention time (RT) are used as primary pre-screening criteria for unknown identification. This produces a highly qualified list for processing and subsequent identification.

Using standard quadrupole spectra from the reference library, a set of rules is followed for identification. The existing GC-MS spectral databases (e.g., as provided by NIST and AMDIS) are used for identifying an unknown compound by mass spectrometry. The data in these databases were collected from samples analyzed on a quadropole mass spectrometer. However, ion trap mass spectra can differ slightly or significantly from spectra collected on a quadrupole mass spectrometer. Thus, when ion trap spectra are searched against mass spectral libraries (e.g., NIST, AMDIS, etc) that are predominately quadrupole spectra, the results are often incorrect, e.g., an incorrect (e.g., lower) probability score is returned or the compound is not identified. This problem results in a lower confidence of identification or a failure to identify the correct compound.

As such, improved search technologies are provided for using existing GC-MS reference libraries with ion trap and other mass spectrographic technologies. In particular, the primary search is based on comparisons of KRI. In some aspects, the technology relates to the use of a performance validation standard that is used to determine the KRI of selected compounds on the GC-MS. Using these data, the X-axis of the conventional gas chromatograph is converted to KRI indices. The compounds from the performance validation standard are used as internal standards to convert the RT of unknowns into a KRI unit. A window of KRI units is determined based on the calculated KRI and reference database and candidates are selected from within that window. The software then looks for common mass fragments within the selected spectra, assigning a probability factor to each. A MS transformation is performed on each of the selected spectra based on functional group classification and how each functional group behaves in the MS. The functional group data are collected for compounds from each of the following functional groups to determine the MS transform characteristics of each group: aldehyde, hydroxyl, alkane, ketone, amine, chloro-containing, bromo-containing, aromatic, phosphorus-containing, nitrogen-containing, sulfur-containing, ether, and ester.

Factors that are considered in the search include, but are not limited to:
base spectral peak MS vs. library
molecular ion peak vs. library
presence of M+1
presence of dimer and dimer+1
MS fragmentation pattern vs. library
mass shift
leading edge spectra

In some embodiments, the calculated KRI and information about the unknown compound (e.g., chemical family, relative purity, source, application (e.g., chemical weapons detection), etc.) are used to modify the method of assessing the MS peaks. That is, for some KRI values, some MS peaks are given more or less weight in the MS deconvolution and matching based on known theoretical or empirical data for the MS matching involved.

### 3. Use of EKRI Values as a Library Pre-Screen

In some embodiments, the KRI determined from the RT, the error in the calculated KRI, the complexity of the unknown compound, the relatedness of the unknown compound to known compounds, and other factors are used to select the sublibrary that is used.

Use of the EKRI values is demonstrated by the following example in which searching a standard unknown library (e.g., the National Institute of Standards Mass Spectral Database) for an unknown compound produced a number of hits based solely on the mass spectrum. For example, a test unknown compound produced the top three hits:

| Database entry | Score |
|---|---|
| aniline | 957 |
| silanediamine, 1,1-dimethyl-N,N′-diphenyl- | 938 |
| pyridine, 4-methyl- | 888 |

Based on the minimal differences in the search scores, indicating that the spectra are similar, it is not possible to confirm which of these compounds is the correct identification for the test unknown. Positive identification would require that a standard of the top hits be obtained and run on the system using the exact same conditions as the unknown sample to determine the actual retention times for confirmation. Using the above referenced algorithm, the EKRIs for the three top hits are estimated as:

| Compound | EKRI |
|---|---|
| aniline | 66.52 |
| silanediamine, 1,1-dimethyl-N,N′-diphenyl- | 184.63 |
| pyridine, 4-methyl- | 39.03. |

The measured retention time of the unknown compound was 74.94. Using both the mass spectral match scores and the EKRIs produces combined probability search results:

| Compound | probability score |
|---|---|
| aniline | 0.96 |
| silanediamine, 1,1-dimethyl-N,N′-diphenyl- | 0.62 |
| pyridine, 4-methyl- | 0.86. |

This provides additional confidence in the identification.

In some embodiments, the GC-MS matches are reported to a user. In some embodiments, the data reported comprise full MS spectra. To maximize the efficiency of data transmission and storage, in some embodiments only a MS peak table is reported or transmitted. In some embodiments, probabilities for each match candidate are reported. In some embodiments, the match candidates are sorted by some metric (e.g., a confidence level) and in some embodiments, an alert is provided to a user based on the matches returned (e.g., a chemical or biological weapon, an environmental toxin, etc.).

### EXAMPLES

### Example 1

During the development of embodiments of the present technology, experiments were performed to assess the feasibility of using a KRI-based primary search to improve the quality of hits when searching the NIST database with GC-MS spectra.

Methods

A vapor calibrator was constructed that produces a constant concentration for 2-4 compounds. Two compounds from the vapor calibrator mix were selected as KRI standards, one eluting in the first minute of the chromatogram, the second at around 1.5 minutes. The slope and intercept of a regression line for these two compounds were determined and used to calculate an estimated KRI (EKRI) according to the following formula

unknown EKRI=RT(in seconds)*slope+offset.

Twenty-five chemicals from nine different functional groups were then run on duplicate GC-MS instruments (Guardion 7 GC-MS, TORION Technologies). EKRI was calculated and compared to the KRI from the NIST library to evaluate the match of the estimated value with the value in the NIST database. The EKRI calculated form the two duplicate GC-MS systems was also compared.

Results

Non-polar compounds produced an EKRI which differed from the NIST by no more than 40 KRI units. The EKRI for polar compounds were all higher than the KRI from the NIST library. For polar compounds the EKRI differed by less than 100 KRI units for all compounds except formaldehyde. The EKRI calculated on duplicate instruments demonstrated excellent agreement. These results demonstrate that a system of EKRI is useful for pre-selecting compounds from the NIST library as match candidates and as a factor in determining the match quality.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in pharmacology, biochemistry, medical science, or related fields are intended to be within the scope of the following claims.

We claim:

1. A method for identifying an unknown compound using gas chromatography-mass spectrometry (GC-MS), wherein the method comprises:
a) estimating a predicted retention index for a standard compound based on an atomic structure of the standard compound; and
b) assigning the predicted retention index to the standard compound.

2. The method of claim 1 wherein the estimating step comprises:
i) determining an atom type and a bond type for each atom of the standard compound;
ii) selecting a reference compound from a database, wherein the reference compound has a known retention index and consists of the same atom types and the same bond types as the standard compound;
iii) assigning a coefficient to each atom of the reference compound, wherein the coefficient characterizes the contribution of an atom to the known retention index of the reference compound; and
iv) using the coefficient to estimate a retention index for the standard compound.

3. The method of claim 2 comprising selecting a plurality of reference compounds from the database to provide a training set, wherein each compound of the training set has a known retention index and consists of the same atom types and the same bond types as the standard compound.

4. The method of claim 2 wherein assigning a coefficient comprises constructing a matrix.

5. The method of claim 4 wherein a column of the matrix corresponds to the atom type and a row of the matrix corresponds to a compound from the database, wherein the compound has a known retention index and consists of the same atom types and the same bond types as the standard compound.

6. The method of claim 1 further comprising determining a precision of the estimated retention index.

7. The method of claim 6 further comprising sorting a database using the precision of the estimated retention index.

8. The method of claim 6 further comprising partitioning a database using the precision of the estimated retention index.

9. The method of claim 6 further comprising using the precision of the estimated retention index to provide a search window.

10. The method of claim 1 further comprising estimating a retention index for the unknown compound assayed by GC-MS.

11. The method of claim 10 wherein the estimating comprises:
i) measuring a retention time of the unknown compound;
ii) converting the retention time of the unknown compound to the retention index for the unknown compound using a known relationship between retention time and retention index.

12. The method of claim 10 further comprising using the retention index for the unknown compound to preselect standard compounds from a database and matching the unknown compound to a standard compound.

13. A method for identifying an unknown compound using GC-MS, wherein the method comprises:
a) estimating retention indices for the compounds of a standard library based on the atomic structure of each compound;
b) estimating a retention index for an unknown compound using the GC-MS retention time data for the unknown compound and a known relationship between retention time and retention index; and
c) using the retention index estimated for the unknown compound to preselect a subset of library compounds from the standard library for subsequent match identification.

14. A system for identifying an unknown compound using GC-MS, the system comprising:
a) a GC-MS apparatus;
b) a database of standard compounds;
c) a processor configured to perform a method according to claim 1.

15. The system of claim 14 wherein the GC-MS apparatus is remote from the database of standard compounds.

16. The system of claim 14 wherein the processor is configured to provide a library of standard compounds indexed by retention index.

17. The system of claim 14 wherein the processor is configured to select a sublibrary from the database of standard compounds.

18. The system of claim 14 wherein the database of standard compounds is partitioned into two or more sublibraries.
